(19) United States
(12) Patent Application Publication
(10) Pub. No.: US 2004/0231707 A1
(43) Pub. Date: Nov. 25, 2004

(54) Decontamination of supercritical wafer processing equipment

(76) Inventors: Paul Schilling, Granite Bay, CA (US); Joseph Hillman, Scottsdale, AZ (US)

Correspondence Address: HAVERSTOCK & OWENS LLP, 162 NORTH WOLFE ROAD, SUNNYVALE, CA, 94086, US

(21) Appl. No.: 10/442,319

(22) Filed: May 20, 2003

(51) Int. Cl. B08B 3/00

(52) U.S. Cl. 134/34; 134/19; 134/26; 134/22.1; 134/108

(57) ABSTRACT

A method is disclosed for decontaminating a supercritical processing apparatus and/or wafers after a wafer cleaning step. In accordance the embodiments of the invention, a supercritical cleaning step utilizes a surfactant to clean a wafer and uses a supercritical rinse solution in a post-cleaning step to decontaminate the supercritical processing apparatus, the wafer or both from processing residues. In accordance with further embodiments of the invention, supercritical rinse solutions are used to cure processing surfaces of the supercritical processing apparatus after the supercritical processing apparatus is serviced or when replacement parts are installed.

### FIELD OF THE INVENTION

This invention relates to supercritical processing systems, devices and methods. More particularly, the present invention relates to supercritical processing systems, devices and methods that utilize surfactants.

### BACKGROUND OF THE INVENTION

A number of systems and methods have been developed for cleaning wafers and/or micro-structures using supercritical solutions. For example, in the U.S. patent application Ser. No. 09/389,788, filed Sep. 3, 1999, and entitled “REMOVAL OF PHOTORESIST AND PHOTORESIST RESIDUE FROM SEMICONDUCTORS USING SUPERCRITICAL CARBON DIOXIDE PROCESS, Mullee describes a process for post-etch treatment of a wafer to remove photoresist and photoresist residue using a supercritical cleaning solution comprising supercritical carbon dioxide and a stripper chemical, such as an amine. In the U.S. patent application Ser. No. 09/697,222, filed Oct. 25, 2000, and entitled “REMOVAL OF PHOTORESIST AND RESIDUE FROM SUBSTRATE USING SUPERCRITICAL CARBON DIOXIDE PROCESS”, now U.S. Pat. No. 6,306,645, Mullee et al. describe a process of post-etch treatment of a wafer using a supercritical solution comprising supercritical carbon dioxide and aqueous fluoride which undercuts the photoresist and residue, thereby allowing the photoresist and residue to be released from the underlying substrate material. The U.S. patent application Ser. No. 09/389,788, filed Sep. 3, 1999, and entitled “REMOVAL OF PHOTORESIST AND PHOTORESIST RESIDUE FROM SEMICONDUCTORS USING SUPERCRITICAL CARBON DIOXIDE PROCESS” and the U.S. patent application Ser. No. 09/697,222, filed Oct. 25, 2000 and entitled “REMOVAL OF PHOTORESIST AND RESIDUE FROM SUBSTRATE USING SUPERCRITICAL CARBON DIOXIDE PROCESS” are both hereby incorporated by reference.

Since the inception of the above applications for using supercritical solutions in wafer processing, a number of supercritical processing systems have been developed. In any wafer fabrication process important to maintain low levels of contaminants. In general, contaminants herein refer to particles, oils and/or residues that can collect on the processing equipment and/or the wafer during a supercritical carbon dioxide processing step. The contaminants can originate from a number of different sources. For example, contaminants can originate from the raw materials used in the process, such as a stock carbon dioxide source and/or the chemicals used in the process. Contaminants can also originate from the supercritical processing equipment itself, especially portions of the supercritical processing equipment with moving parts, such pumps valves and/or fans, or from the parts when they are replaced or serviced. Further contaminants can form during the supercritical process step, when the contaminates can “build up” in the processing equipment over time and contaminate subsequently processed wafers. For example, while removing a post-etch residue from a wafer using stripper chemicals or caustic chemicals in order to help dissolve and/or break up the residue, new species or materials can be formed in a process step that contaminate the processing equipment, the wafer or both. Regardless of the source of contamination, the buildup of contaminants in supercritical processing equipment eventually leads to unacceptable wafer processing conditions. Therefore, there is a continued need for supercritical wafer systems that are capable of maintaining low levels of contaminants and for a method for removing contaminates from supercritical wafer equipment either during a wafer processing step or as a post wafer-processing step.

### SUMMARY OF THE INVENTION

The present invention is directed to a method for decontaminating supercritical processing equipment. The method of the present invention is utilized to decontaminate supercritical wafer processing equipment during and/or after one or more wafer processing steps and/or after servicing of the process equipment. In accordance with the embodiment of the invention, the supercritical wafer processing equipment is decontaminated after replacing one or more functional parts of the equipment, wherein the functional parts are configured to be exposed to a supercritical processing environment during use. Preferably, the supercritical wafer processing equipment is configured to process and/or clean wafers using supercritical carbon dioxide. However, it will be clear to one skilled in the art that the method of the present invention can be used to decontaminate supercritical processing equipment that is used in the fabrication of any micro-devices including, but not limited to, micro-mechanical devices, micro-electronic devices, micro-optical devices and combinations thereof and/or to decontaminate supercritical processes equipment configured to used other supercritical solutions.

In accordance with the method of the invention, a substrate structure is treated in a processing chamber of the supercritical processing system using a supercritical cleaning solution. Supercritical cleaning solution herein refers to a supercritical solution that is used to remove a residue, such as a photoresist post-etch residue, or film, such as an anti-reflective coating, from a substrate. The substrate structure, in accordance with the embodiments of the invention, includes a number of different substrate materials, including but not limited to silicon-based materials and/or metal and any number of different patterned, unpatterned layers and/or partial device structures.

The supercritical cleaning solution used to remove a residue from a substrate preferably comprises supercritical carbon dioxide and a surfactant. Surfactants, in accordance with the embodiments of the invention include, but are not limited to, polysiloxanes, fluorocarbons, acrylates, styrenes and fatty acid polymers. Other suitable surfactants considered to be within the scope of the present invention are described in U.S. Pat. No. 6,224,744, issued to DeSimone et al. and U.S. Pat. Nos. 6,270,531 and 6,228,826 issued to De Young et al., the contents of which are all hereby incorporated by reference.

During the treatment of the wafer structure with the supercritical cleaning solution, the residue is substantially removed from the substrate structure by circulating the supercritical cleaning solution over and/or around the substrate structure and through a processing chamber of the supercritical wafer processing equipment. After circulating the supercritical cleaning solution over and/or around the substrate structure and through a processing chamber, the processing chamber is vented to remove the supercrictal cleaning solution and the residue from the processing chamber. In accordance with the embodiments of the present invention, the cleaning solution is subjected to a series of compression and decompression cycles during the cleaning process, as described in detail below.

During the cleaning process, a residual amount of the surfactant and/or a material generated during the cleaning step can be deposited or formed on surfaces of the supercritical processing equipment (most notably the processing chamber) and/or on the wafer being processed. The residual amount of surfactant and/or other materials deposited on surfaces of the supercritical processing equipment and/or the wafer during a cleaning step are referred to herein as process residues. Process residues can build-up in the supercritical wafer processing equipment over time and eventually result in unacceptable levels of contaminants for processing wafers and/or other micro-devices.

In order to remove process residues from the supercritical processing equipment, a post-cleaning rinse treatment is used. In accordance with the embodiments of the invention, process residues are removed by treating surfaces of the supercritical processing equipment with a supercritical rinse solution comprising a complexing agent and a caustic chemical and exposing surfaces of the supercritical processing equipment to heat, light and/or any combination thereof in order to help break down and/or to increase the solubility of the process residues in a supercritical rinse solution. Preferably, the post cleaning rinse treatment includes treating the processing chamber to a supercritical rinse solution comprising supercritical carbon dioxide and one or more organic solvents. In accordance with a most preferred embodiment of the invention, the supercritical rinse solution comprises a mixture of isopropyl alcohol and acetone and is injected into the processing chamber with supercritical carbon dioxide and is circulated through the processing chamber, as explained in detail below.

The aforementioned method of removing processing residue from a supercritical processing chamber can also be used to remove process residues cleaned from a wafer within the processing chamber. Also, the aforementioned method can be used for decontaminating supercritical processing equipment after servicing the supercritical processing equipment.

In accordance with the method of the present invention, a functional part of the supercritical processing apparatus is changed, wherein the replacement part comprising surfaces that are configured to be exposed to a supercritical processing environment while using the supercritical processing equipment or apparatus. After installing the replacement part, the equipment is treated with a supercritical curing solution comprising a cleaning agent and supercritical carbon dioxide. Preferably, the cleaning agent comprises a mixture of isopropyl alcohol and acetone. However, it will be clear to one skilled in the art that the cleaning agent can comprise corrosive chemicals such as hydrogen fluoride and/or surfactants. When the cleaning agent comprises a surfactant, a curing residue can result, for the reasons previously mentioned. Accordingly, the supercritical processing equipment may require a post-curing rinse treatment to fully decontaminate the supercritical processing equipment, such as by treating the equipment to a supercritical rinse solution, described previously.

### BRIEF DESCRIPTION OF THE DRAWINGS

FIGS. 1A-B show schematic representations of a micelle and a reverse micelle, respectively.

FIG. 2 shows a simplified schematic of a supercritical wafer processing apparatus, in accordance with the embodiments of the invention.

FIG. 3 shows a detailed schematic diagram of a supercritical processing apparatus, in accordance with the embodiments of the invention.

FIG. 4 is a plot of pressure versus time for a supercritical cleaning, rinse or curing processing step, in accordance with the method of the present invention.

FIG. 5 is a schematic block diagram outlining steps for decontaminating a supercritical processing apparatus, in accordance with the embodiments of the present invention.

FIG. 6 is a schematic block diagram outlining the steps for decontaminating a supercritical processing apparatus after replacement of a functional part, in accordance with further embodiments of the present invention.

### DETAILED DESCRIPTION OF THE INVENTION

In accordance with a preferred method of the present invention, a wafer with a processing residue, such as a post-etch residue, is cleaned in a supercritical processing apparatus using a supercritical cleaning solution comprising supercritical carbon dioxide and one or more surfactants. Surfactants are capable of forming a “micelle emulsion” or micelle structures, such as those described below. Generally a micelle emulsion includes micelle structures suspended in a continuous phase, and reverse micelle emulsion includes reverse micelle structures suspended in the continuous phase. Micelles and reverse micelles are colloidal aggregates formed from a surfactant and molecules and/or particles, wherein the surfactant facilitates the ability of the molecules and/or particles to be taken-up, suspended and/or dissolved into a solvent medium.

For micelles, the colloidal aggregates include non-polar molecules surrounded by amphipathic molecules. For the reverse micelles, the colloidal aggregates include polar molecules surrounded by the amphipathic molecules. An amphipathic species is generally referred to herein as a molecular species having one or more hydrophillic groups (i.e., groups that are attracted to a polar species such as water) and one or more hydrophobic groups (i.e., groups that are attracted to a non-polar species such as oil). Many types of amphipathic species comprise a hydrophillic head and a hydrophobic tail.

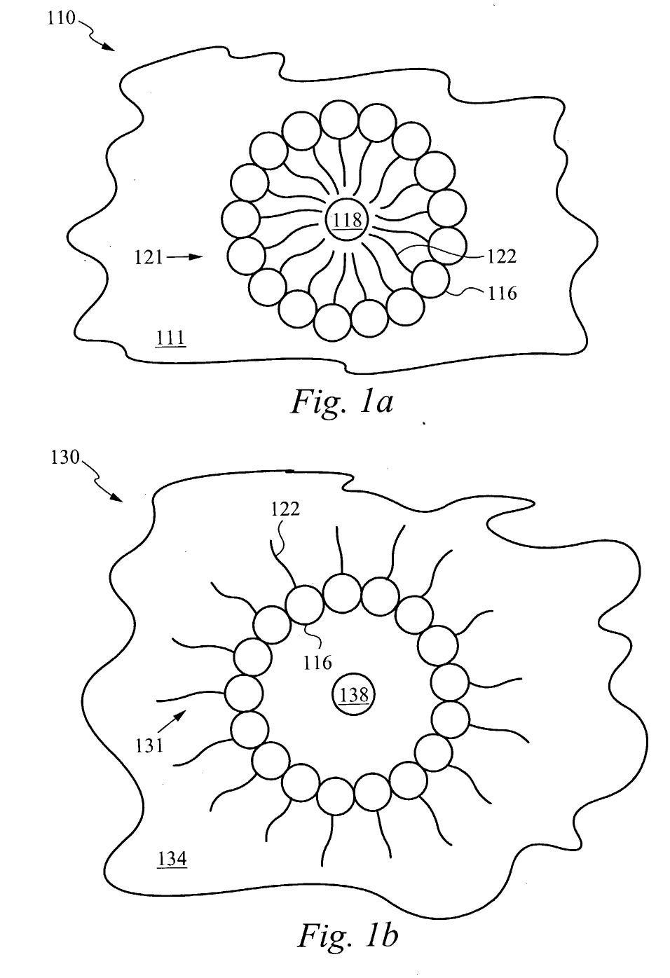

FIG. 1A shows a schematic representation of micelle structure 110 formed in a polar solvent medium 111. The micelle structure 110 includes amphiphillic molecules 121 comprising polar (hydrophillic) heads 116 and a non-polar (hydrophobic) tails 122. The non-polar tails 122 are capable of surrounding a non-polar molecule or particle 118 and help to suspend or solubilize the non-polar molecule or particle 118 in the polar solvent medium 111.

FIG. 1B shows a schematic representation of a reverse micelle structure 130 formed in a non-polar solvent medium 134. The reverse micelle structure 130 includes amphiphillic molecules 131 that have polar (hydrophillic) heads 116 and non-polar (hydrophobic) tails 122. The polar heads 116 of the amphiphillic molecules 131 are capable of surrounding a polar molecule or particles 138 and help to suspend or solubilize the polar molecule or particle 138 in the non-polar solvent medium 134.

While surfactants, herein, have been generally described as amphipathic species, which can be used to help suspend or solubilize non-polar molecules or particles in a polar solvent medium or to help suspend or solubilize polar molecules or particles in a non-polar solvent medium, it will be understood by one skilled in the art that surfactants also refer to substances that lower surface tension of the solvent medium.

Recently, interest has developed in using micelles or reverse micelles in supercritical fluid for cleaning wafer structures. For example, using surfactants in supercritical CO₂ for cleaning wafers has been proposed in U.S. Pat. No. 6,224,744, issued to DeSimone et al. and U.S. Pat. Nos. 6,270,531 and 6,228,826 both issued to DeYoung et al. all referenced previously. While surfactants have shown promise for use in cleaning wafers in a supercritical cleaning process, such surfactants can also lead to buildup of contaminants in the supercritical wafer processing equipment used.

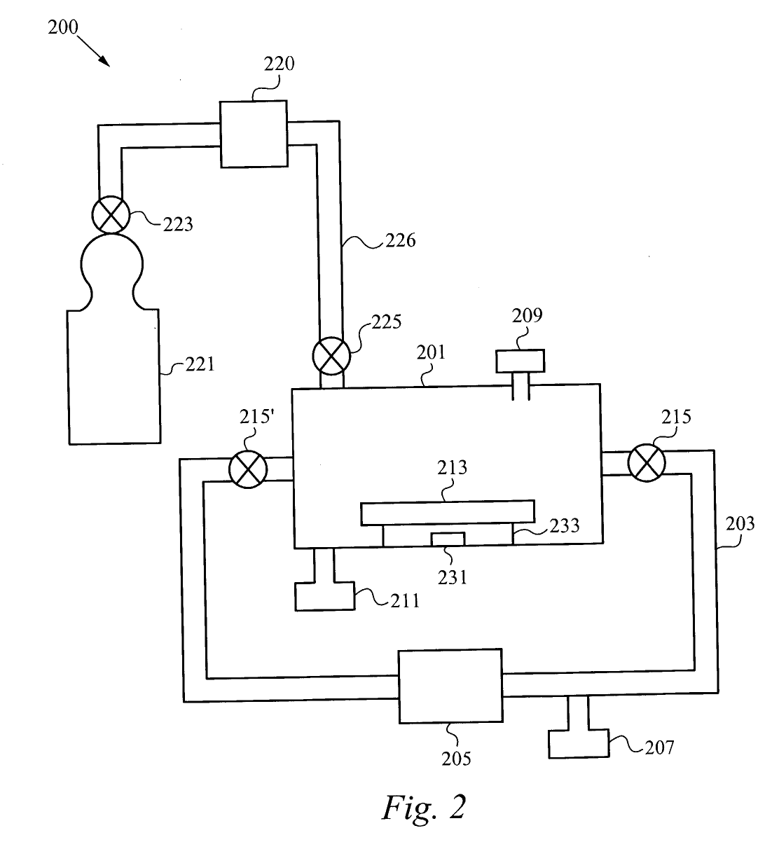

FIG. 2 shows a simplified schematic of a supercritical processing apparatus 200. The apparatus 200 comprises a carbon dioxide source 221 that is connected to an inlet line 226 through a source valve 223 which can be opened and closed to start and stop the flow of carbon dioxide from the carbon dioxide source 221 to the inlet line 226. The inlet line 226 is preferably equipped with one or more back-flow valves, pumps and heaters, schematically shown by the box 220, for generating and/or maintaining a stream of supercritical carbon dioxide. The inlet line 226 also preferably has an inlet valve 225 that is configured to open and close to allow or prevent the stream of supercritical carbon dioxide from flowing into a processing chamber 201.

Still referring to FIG. 2, the processing chamber 201 is preferably equipped with one or more pressure valves 209 for exhausting the processing chamber 201 and/or for regulating the pressure within the processing chamber 201. Also, the processing chamber 201, in accordance with the embodiments of the invention is coupled to a pump and/or a vacuum 211 for pressurizing and/or evacuating the processing chamber 201.

Again referring to FIG. 2, within the processing chamber 201 of the apparatus 200 there is preferably a chuck 233 for holding and/or supporting a wafer structure 213. The chuck 233 and/or the processing chamber 201, in accordance with further embodiments of the invention, has one or more heaters 231 for regulating the temperature of the wafer structure 213 and/or the temperature of a supercritical processing solution within the processing chamber 201.

The apparatus 200, also preferably has a circulation line or loop 203 that is coupled to the processing chamber 201. The circulation line 203 is preferably equipped with one or more valves 215 and 215′ for regulating the flow of a supercritical processing solution through the circulation line and through the processing chamber 201. The circulation line 203 is also preferably equipped with any number of back-flow valves, pumps and/or heaters, schematically represent by the box 205, for maintaining a supercritical process solution and for flowing supercritical process solution through the circulation line 203 and through the processing chamber 201. In accordance with a preferred embodiment of the invention, the circulation line 203 has one or more injection ports or regions 207 for introducing chemistry, such as surfactants, caustic chemicals and solvents, into the circulation line 203 and for generating supercritical cleaning, rinse and curing solutions in situ.

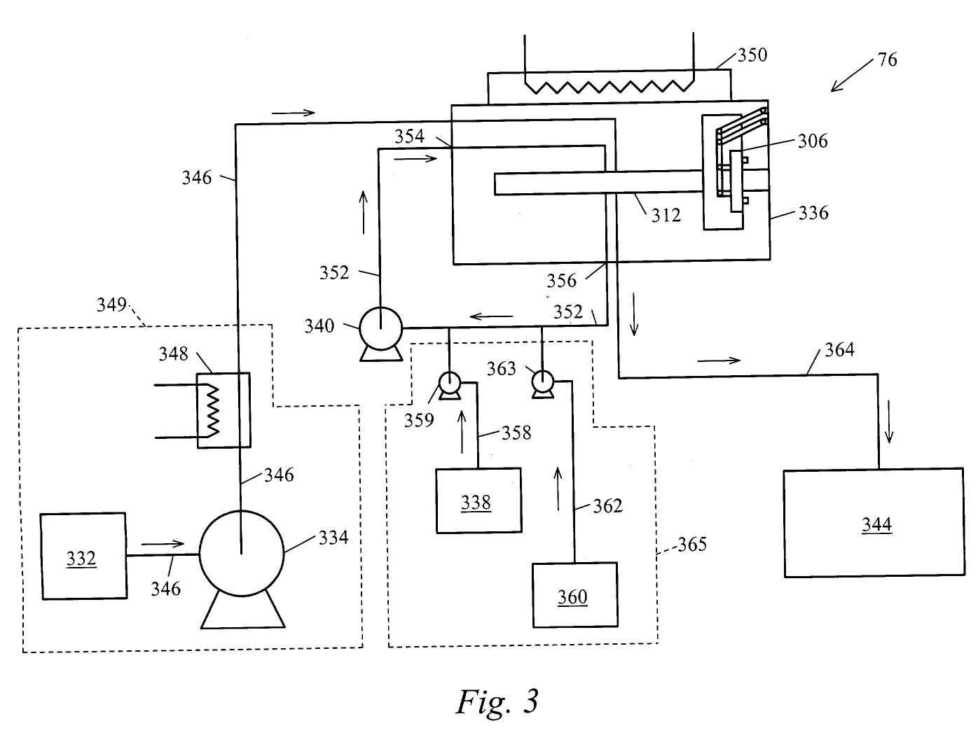

FIG. 3 shows a supercritical processing apparatus 76 in more detail than FIG. 2 described above. The supercritical processing apparatus 76 is configured for generating and for treating wafer with supercritical cleaning, rinse and curing solutions and for treating a wafer with them. The supercritical processing apparatus 76 includes a carbon dioxide supply vessel 332, a carbon dioxide pump 334, a processing chamber 336, a chemical supply vessel 338, a circulation pump 340, and an exhaust gas collection vessel 344. The carbon dioxide supply vessel 332 is coupled to the processing chamber 336 via the carbon dioxide pump 334 and carbon dioxide piping 346. The carbon dioxide piping 346 includes a carbon dioxide heater 348 located between the carbon dioxide pump 334 and the processing chamber 336. The processing chamber 336 includes a processing chamber heater 350. The circulation pump 340 is located on a circulation line 352, which couples to the processing chamber 336 at a circulation inlet 354 and at a circulation outlet 356. The chemical supply vessel 338 is coupled to the circulation line 352 via a chemical supply line 358, which includes a first injection pump 359. A rinse agent supply vessel 360 is coupled to the circulation line 352 via a rinse supply line 362, which includes a second injection pump 363. The exhaust gas collection vessel 344 is coupled to the processing chamber 336 via exhaust gas piping 364.

The carbon dioxide supply vessel 332, the carbon dioxide pump 334, and the carbon dioxide heater 348 form a carbon dioxide supply arrangement 349. The chemical supply vessel 338, the first injection pump 359, the rinse agent supply vessel 360, and the second injection pump 363 form a chemical and rinse agent supply arrangement 365.

It will be readily apparent to one skilled in the art that the supercritical processing apparatus 76 includes valving, control electronics, filters, and utility hookups which are typical of supercritical fluid processing systems.

Still referring to FIG. 3, in operation a wafer (not shown) with a residue thereon is inserted into a wafer cavity 312 of the processing chamber 336 and the processing chamber 336 is sealed by closing a gate valve 306. The processing chamber 336 is pressurized by the carbon dioxide pump 334 with the carbon dioxide from the carbon dioxide supply vessel 332 and the carbon dioxide is heated by the carbon dioxide heater 348 while the processing chamber 336 is heated by the processing chamber heater 350 to ensure that a temperature of the carbon dioxide in the processing chamber 336 is above a critical temperature. The critical temperature for the carbon dioxide is 31° C. Preferably, the temperature of the carbon dioxide in the processing chamber 336 is within a range of 45° C. to 75° C. Alternatively, the temperature of the carbon dioxide in the processing chamber 336 is maintained within a range of from 31° C. to about 100° C.

Upon reaching initial supercritical conditions, the first injection pump 359 pumps the process chemistry from a chemical supply vessel 338 into the processing chamber 336 via the circulation line 352 while the carbon dioxide pump 334 further pressurizes the supercritical carbon dioxide. At the beginning of the addition of process chemistry to the processing chamber 336, the pressure in the processing chamber 336 is preferably about 1,100-1,200 psi. Once a desired amount of the process chemistry has been pumped into the processing chamber 336 and desired supercritical conditions are reached, the carbon dioxide pump 334 stops pressurizing the processing chamber 336, the first injection pump 359 stops pumping process chemistry into the processing chamber 336, and the circulation pump 340 begins circulating the supercritical process solution comprising the supercritical carbon dioxide and the process chemistry. Preferably, the pressure at this point within the processing chamber 336 is about 2,700-2,800 psi. By circulating the supercritical processing solution, supercritical processing solution is replenished quicky at the surface of the wafer thereby enhancing the rate of treating the wafer (not shown) and/or decontaminating the processing chamber 336 and the circulation line 352 and/or curing the supercritical processing apparatus 76 after service or maintenance, as described in detail below.

When a wafer (not shown) is being processed within the processing chamber 336, the wafer is held using a mechanical chuck, a vacuum chuck or other suitable holding or securing means. In accordance with the embodiments of the invention the wafer is stationary within the processing chamber 336 or, alternatively, is rotated, spun or otherwise agitated during the supercritical process step.

After the supercritical process solution is circulated though the circulation line 352 and the processing chamber 336, the processing chamber 336 is partially depressurized by exhausting some of the supercritical process solution to an exhaust gas collection vessel 344 in order to return conditions in the processing chamber 336 to near the initial supercritical conditions. Preferably, the processing chamber 336 is cycled through at least one such decompression and compression cycles before the supercritical process solution is completely exhausted from the processing chamber 336 and into the collection vessel 344. After exhausting the pressure chamber 336, a second supercritical process step is performed or the wafer is removed from the processing chamber 336 through the gate valve 306, and the wafer processing is continued on a second processing apparatus or module (not shown).

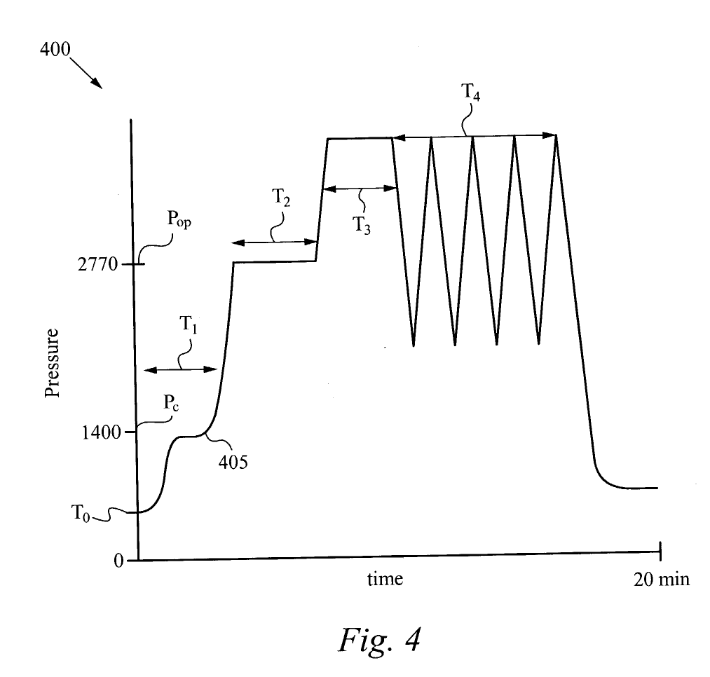

FIG. 4 illustrates an exemplary plot 400 of pressure versus time for a supercritical processing step, such as a supercritical cleaning step, a supercritical rinse step or a supercritical curing step, in accordance with the method of the present invention. Now referring to both FIGS. 3 and 4, prior to an initial time T₀, the wafer structure with a residue thereon, is placed within the processing chamber 336 through the gate valve 306 and the processing chamber 336 is sealed. From the initial time T₀ through a first duration of time T₁, the processing chamber 336 is pressurized. When the processing chamber 336 has reached a critical pressure P_{c} (1,070 psi) then a process chemistry is injected to the processing chamber 336, preferably through the circulation line 352, as explained previously. The process chemistry preferably includes a surfactant such as a polysilene. The injection of several quantities of process chemistry can be performed over the duration of time T₁ to generate a supercritical processing solution with the desired concentration of process chemistry. The process chemistry, in accordance with the embodiments of the invention, can also include one more or more carrier solvents. Preferably, the injection(s) of the process chemistry begin upon reaching about 1100-1200 psi, as indicated by the inflection point 405. Alternatively, the process chemistry is injected into the processing chamber 336 around the a second time T₂ or after the second time T₂.

After the processing chamber 336 reaches an operating pressure Pₒₚ at the second time T₂, which is preferably about 2,800 psi but can be any value so long as the operating pressure is sufficient to maintain supercritical conditions, the supercritical process solution is circulated over and/or around the wafer and through the processing chamber 336 using the circulation line 352, such as described above. Next, the pressure within the processing chamber 336 is increased and over a duration of time T₃ while the supercritical processing solution continues to be circulated over and/or around the wafer and through the processing chamber 336 using the circulation line 352. At any time over the duration of times T₁, T₂ and T₃ the concentration of the process chemistry in the supercritical solution can be adjusted by a push-through process, as described below.

Still referring to FIG. 4, preferably over the duration of time T₃, a fresh stock of supercritical carbon dioxide is fed into the processing chamber 336, while the supercritical cleansing solution along with process residue suspended or dissolved therein is simultaneously displaced from the processing chamber 336 through a vent line 364. After the push-trough step is complete, then over a duration time T₄, the processing chamber 336 is cycled through a plurality of decompression and compression cycles. Preferably, this is accomplished by venting the processing chamber 336 below operating pressure Pₒₚ to about 1,100-1,200 psi in a first exhaust and then raising the pressure from 1,100-1,200 psi to the operating pressure Pₒₚ or above with a first pressure recharge. After the decompression and compression cycles are completed after the duration of time T₄, then the processing chamber 336 is completely vented or exhausted to atmospheric pressure. In the case of wafer processing, a next wafer processing step begins or the wafer is removed from the processing chamber 336 and can be moved to a second processing module to continue processing.

The plot 400 is provided for exemplary purposes only. It is understood that a supercritical processing step can have any number of different time/pressure and/or temperature profiles without departing from the scope of the present invention. Further, any number of cleaning and rinse processing sequences with each step having any number of decompression and compression cycles are contemplated. Also, as stated previously, concentrations of various chemicals and species within a supercritical process solution can be readily tailored for the application at hand and altered at anytime within a supercritical processing step.

In a preferred embodiment of the invention, the cleaning step, such as described above, is utilized to decontaminate supercritical processing equipment after servicing the equipment and/or exchanging one or more parts of the equipment with surfaces that are exposed to a supercritical processing environment when the equipment is in use. In further embodiments of the invention, the cleaning step, such as described above, utilizes a surfactant to remove a residue from a wafer and the cleaning process step is followed by a rinse processing step which utilizes a supercritical rinse solution comprising supercritical carbon dioxide and one or more rinse chemicals or solvents to remove processing residues from the chamber, the wafer or both.

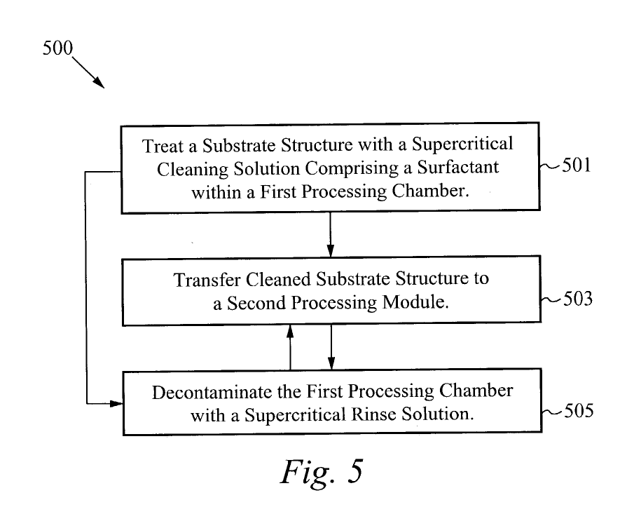

FIG. 5 shows a schematic block diagram 500 outlining steps for decontaminating the supercritical processing apparatus after a cleaning processing step involving the use of a surfactant, such as described above. After the substrate structure is treated with a supercritical cleaning solution in the step 501, thereby generating process residues, in the step 503 the substrate structure is removed from the processing chamber for further processing. After, the substrate structure is removed from the processing chamber in the step 503, in the step 505 the processing chamber is treated with supercritical rinse solution. Alternatively, the substrate structure remains within the processing chamber and in the step 505 the processing chamber and the substrate structure are simultaneously decontaminated of the process residues generated in the cleaning step 501.

A supercritical rinse solution used to decontaminate a processing chamber, a wafer or both, in accordance with the embodiments of the invention, comprises supercritical carbon dioxide and a cleaning agent. Preferably, the cleaning agent comprises a mixture of organic solvents, such as a mixture of an alcohol and a ketone. In accordance with a preferred embodiment of the invention, the invention the cleaning agent comprises a mixture of isopropyl alcohol and acetone. In further embodiments of the invention the cleaning agent further comprises a surfactant, including but not limited to, polysiloxanes, fluorocarbons, acrylates, styrenes, fatty acid polymers other carboxylates and amines. Preferably, the surfactant comprises a carbon chain backbone with five or more carbon atoms. In still further embodiments of the invention the cleaning agent further comprises a complexing agent and/or a reactive compounds, which are capable complexing, reacting with and/or decomposing processing residues generated in a supercritical cleaning step. Example of complexing agents include, but are not limited to, hexafluoroacetylacetone (Hfaa), acetylacetone (Acac) and ethylenediaminetetraacetic acid (EDTA). The decontamination step 505 preferably comprises generating the supercritical rinse solution in situ, as described previously.

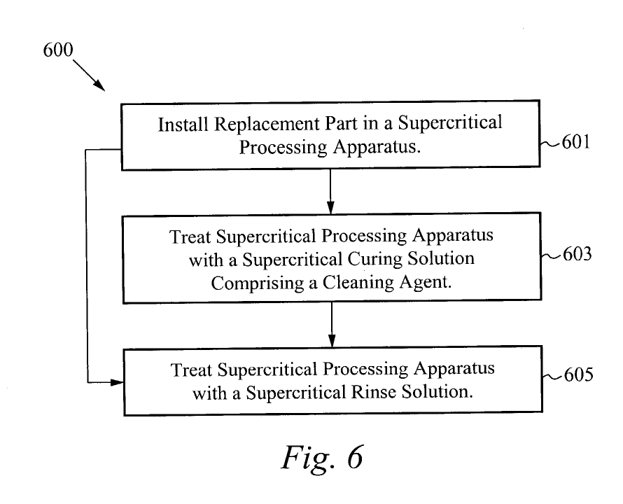

FIG. 6 shows a schematic block diagram 600 outlining the steps for decontaminating a supercritical processing apparatus after the apparatus is serviced by replacing one or more parts that have surfaces that are subjected to a supercritical processing environment during a supercritical processing step. In the step 601, replacement parts are installed in the supercritical processing apparatus. After the replacement parts are installed in the step 601, the supercritical wafer processing apparatus is treated with a supercritical solution comprising supercritical carbon dioxide and a mixture of alcohol and a ketone, such as described in detail above. Preferably, the supercritical rinse solution in generated within the apparatus and circulated through the pressure chamber via a circulation line, as described above.

Still referring to FIG. 6, in accordance with further embodiments of the invention, prior to a step 605 of treating the supercritical processing apparatus with a supercritical rinse solution, in the step 603, the apparatus is treated with a supercritical curing solution. The supercritical curing solution can include a corrosive chemical, such as aqueous hydrogen fluoride. The supercritical curing solution, in accordance with alternative embodiments of the invention comprises one or more surfactants and/or one or more organic solvents. After the supercritical processing apparatus is treated with the curing solution, process residues are removed from processing surfaces of the apparatus by treating the apparatus with a supercritical rinse solution, as described above.

The supercritical curing solution, like a supercritical cleaning solution and a supercritical rinse solution, is preferably generated in situ by injecting curing chemistry directly into the processing chamber or through a circulation line. The supercritcial curing solution is also preferably cycled through a range of different pressures and circulated through the processing chamber, as described in relation to FIG. 4.

The present invention has been described in terms of specific embodiments incorporating details to facilitate the understanding of the principles of construction and operation of the invention. As such, references, herein, to specific embodiments and details thereof are not intended to limit the scope of the claims appended hereto. It will be apparent to those skilled in the art that modifications can be made in the embodiment chosen for illustration without departing from the spirit and scope of the invention.

What is claimed is:

1. A method comprising:
a. maintaining a first substrate structure comprising a substrate material and residue thereon within a chamber using a supercritical cleaning solution, the supercritical solution comprising supercritical carbon dioxide and a surfactant;
b. removing a substantial portion of the surfactant and the residue away from the substrate material, wherein a residual surfactant remains within the chamber; and
c. removing the residual surfactant from within the chamber.

2. The method of claim 1, wherein the first substrate structure is removed from the chamber prior to removing the residual surfactant from within the chamber.

3. The method of claim 2, further comprising placing a second substrate structure within the chamber and repeating (a) through (c).

4. The method of claim 1, wherein removing the residual surfactant comprises treating the chamber with a rinse solution.

5. The method of claim 4, wherein treating the chamber with a rinse solution comprises:
a. introducing the rinse solution into the chamber;
b. circulating the rinse solution through the chamber; and
c. removing the rinse solution from the chamber.

6. The method of claim 5, wherein the rinse solution comprising supercritical carbon dioxide.

7. The method of claim 6, wherein the rinse solution further comprises at least one of an alcohol and a ketone.

8. The method of claim 6, wherein the rinse solution further comprises a complexing agent.

9. The method of claim 1, wherein removing the residual surfactant from the chamber comprises decomposing the residual surfactant.

10. The method or claim 9, wherein decomposing the surfactant comprises heating the chamber.

11. The method of claim 1, wherein removing the residual surfactant comprises treating the chamber with a complexing agent selected from the group consisting of hexafluoroacetylacetone (Hfaa), acetylacetone (Acac) and ethylenediaminetetraacetic acid (EDTA).

12. A method of treating a substrate structure comprising:
a. exposing the substrate structure to a cleaning solution comprising supercritical carbon dioxide and a surfactant for removing a residue from the substrate; and
b. exposing the substrate structure to a rinse solution comprising an agent for removing residual surfactant from the substrate.

13. The method of claim 12, wherein the surfactant is a surfactant is a polymer.

14. The method of claim 13, wherein the polymer is selected from the group consisting of a polysiloxane, a fluorocarbon, an acrylate, a styrene and a fatty acid polymer.

15. The method of claim 12, wherein the surfactant is a pentamethyldisiloxane (PDMS).

16. The method of claim 12, wherein the rinse solution comprises an alcohol.

17. The method of claim 16, wherein the alcohol is isopropyl alcohol and the rinse solution further comprises acetone.

18. A method of removing a surfactant contaminant from the chamber comprising:
a. generating a supercritical carbon dioxide within the chamber;
b. injecting a complexing agent into the supercritical carbon dioxide to form rinse solution;
c. circulating the rinse solution within the chamber; and
d. venting the rinse solution from the chamber.

19. The method of claim 18, wherein a pressure within the chamber is cycled through a range of pressures.

20. A apparatus comprising:
a. means for generating supercritical cleaning solution comprising supercritical carbon dioxide and a surfactant;
b. means for circulating the supercritical cleaning solution through a chamber configured to process wafers; and
c. means for removing residual surfactant from the chamber.

21. The apparatus of claim 20, wherein the means for generating the supercritical solution comprises an injection region for introducing the surfactant into the chamber.

22. A method of treating a supercritical processing apparatus, the method comprising:
a. exchanging a functional part of the supercritical processing apparatus, the part comprising surfaces that are configured to be exposed to a supercritical processing environment within the supercritical processing apparatus; and
b. exposing the surfaces to a supercritical curing solution comprising a cleaning agent and supercritical carbon dioxide.

23. The method of claim 22, wherein the cleaning agent comprises an alcohol.

24. The method of claim 23, wherein the cleaning agent further comprises acetone.

25. The method of claim 22, wherein the cleaning agent comprises aqueous hydrogen fluoride.

26. The method of claim 22, wherein the cleaning agent comprises a surfactant.

27. The method of claim 22, further comprising generating a supercritical rinse solution within the apparatus to remove a curing residue.

28. The method of claim 27, wherein the supercritical rinse solution comprises supercritical carbon dioxide and two or more organic solvents.

29. The method of claim 28, wherein the two or more organic solvents comprise isopropyl alcohol and acetone.

30. A method of decontaminating a supercritical processing apparatus comprising:
a. generating a supercritical rinse solution comprising supercritical carbon dioxide and an alcohol Within the apparatus; and
b. circulating the supercritical rinse solution through the apparatus

31. The method of claim 30, wherein generating the supercritical rinse solution comprises:
a. forming a supercritical carbon dioxide environment within the apparatus; and
b. injecting an amount of the alcohol within the supercritical carbon dioxide environment.

32. The method of claim 30, wherein the alcohol isopropyl alcohol and the rinse solution further comprises acetone.

33. The method of claim 30, further comprising cycling the supercritical rinse solutions through a range of pressures.

34. The method of claim 30, further comprising cycling the supercritical rinse solution through a range of temperatures.
